(19) United States
(12) Patent Application Publication
(10) Pub. No.: US 2019/0372918 A1
(43) Pub. Date: Dec. 5, 2019

(54) A SYSTEM FOR GETTING SERVICE OVER INSTANT MESSAGING APPLICATION

(71) Applicant: TURKCELL TEKNOLOJÏ ARASTÏRMA VE GELÏSTÏRME ANONÏM SÏRKETÏ, ANKARA (TR)

(72) Inventor: Çagri GENÇ, ISTANBUL (TR)

(73) Assignee: TURKCELL TEKNOLOJÏ ARASTÏRMA VE GELÏSTÏRME ANONÏM SÏRKETÏ, ANKARA (TR)

(21) Appl. No.: 16/349,695

(22) PCT Filed: Nov. 14, 2017
(86) PCT No.: PCT/TR2017/000125

§ 371 Date: May 14, 2019

(30) Foreign Application Priority Data
Nov. 14, 2016 (TR) 2016/16371

(51) Int. Cl. H04L 12/58

(52) U.S. Cl. CPC H04L 51/046

(57) ABSTRACT

The present invention relates to a system which enables users to add services to their directories as a number and to communicate with the services recorded over the instant messaging application by using message and/or video/voice call channels. The inventive system consists of user communication device, instant messaging server and service management unit.

### TECHNICAL FIELD

The present invention relates to a system which enables users to add services to their directories as a number and to communicate with the services recorded over the instant messaging application by using message and or video/voice call channels.

### BACKGROUND OF THE INVENTION

Today, companies carry their services to different platforms in order to provide notification and service intake of their subscribers. Depending on technological developments, mobile networks are preferred by companies so as to provide service to subscribers.

In common usage in the state of the art, companies provide service to their subscribers over call centers. However, limited service can be provided by the number of staff in usage of call centers. Increasing the number of staff employed at call centers increases financial losses of the company.

In another common usage in the state of the art, providing service to subscribers is realized by means of SMS (Short Message Service) channel of mobile networks. Particularly, delivery service by means of short message used by mobile operators is important in terms of providing automatic service to subscribers. However, providing service by means of short message channel is limited to standards of the mobile network. For example, geographical location information of the person is received over base station instead of GPS (Global Positioning System). In addition to this, service cannot be provided in cases when there is no network connection and in some cases when the subscriber has no credit.

Service cannot be provided to subscribers under all conditions by means of the above-mentioned applications in state of the art. Therefore, a system which enables users to get service under all conditions and over platforms being commonly used today is needed.

The United States patent document no. US20050111653, an application in the state of the art, discloses an automatic interaction method and apparatus which communicates with the user—who initiates call over instant message application—until the customer representative is available.

### SUMMARY OF THE INVENTION

An objective of the present invention is to realize a system which enables users to communicate with the message and call channel over the service units and the instant message application.

Another objective of the present invention is to realize a system which enables users to record services to his/her directory as a number and to communicate with the services recorded in his/her directory over the instant message application.

### DETAILED DESCRIPTION OF THE INVENTION

“A System for Getting Service over Instant Messaging Application” realized to fulfill the objectives of the present invention is shown in the figure attached, in which:

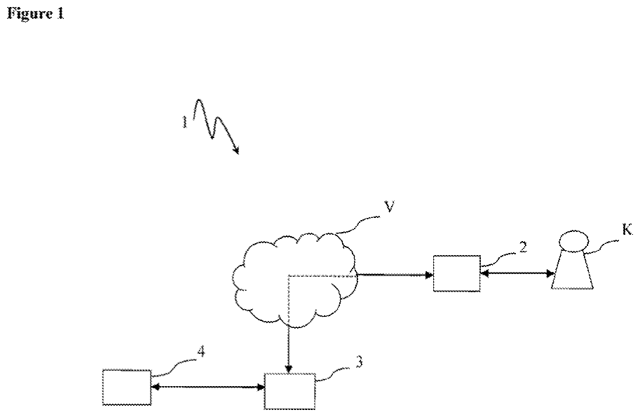

FIG. 1 is a schematic block diagram of the inventive system.

The components illustrated in the figure are individually numbered, where the numbers refer to the following:

1. System

2. User communication device

3. Instant messaging server

4. Service management unit

K: User

V: Data network

The inventive system (1) enabling communication with service units over instant messaging application comprises::
at least one user communication device (2) which can perform data exchange with the data network (V) and whereon application can be run;
at least one instant messaging server (3) which takes the messages transmitted or the voice/video calls initiated over the data network (V) by the user (K) by means of the application running on the user communication device (2), forwards the messages or the calls to the users to whom they will be transmitted, determines the messages or the calls initiated towards the service units and forwards them to the related units, and transmits the messages or the calls reaching the user (K) to the user communication device (2) over the data network (V);
at least one service management unit (4) which answers the messages or the calls forwarded by the instant messaging server (3) or transmits the message content or the call request to the instant messaging server (3) in order to communicate with the user (K). (FIG. 1).

The instant messaging server (3) included in the inventive system (1) is an electronic device which runs application on thereof and can communicate with the data network (V). The user communication device (2) has a structure suitable for running an application which can be interacted with the user (K) and can display the data transmitted from the instant messaging server (3) to the user (K) by means of a suitable interface, on thereof. In the preferred embodiment of the invention, the application running on the user communication device (2) is an instant messaging application that can be communicated by the user (K) over the message and voice/video call channel. In addition, the user communication device (2) has user control units which will enable the user (K) to write message, make choice, record the persons or the services—that s/he will communicate by the definition information required for communication—to the device directory on the interface provided by the application running on thereof. As can be easily understood by a person skilled in the state of the art, the user communication device (2) is at device such as computer, tablet computer, smart phone which has user control units such as a keyboard, mouse or touch screen whereby the user can interact in addition to a screen.

The instant messaging server (3) included in the inventive system (1) is a unit which receives the message or the call request transmitted by the user communication device (2) over the data network (V). The instant messaging server (3) also receives the definition information of the person or the service unit where the message or the call will be forwarded together with the message content or the call request. The instant messaging server (3), which determines that the message or the call will be forwarded to the service unit in accordance with the definition information received by thereof, transmits the message content or the call request to the service management unit (4).

In the event that the service management unit (4) transmits message to the user (K) or initiates call, the instant messaging server (3) receives the message content or the call request to the service management unit (4) together with the user definition information and forwards it to the user communication device (2) over the data network (V).

The service management unit (4) included in the inventive system (1) receives the message content or the call request transmitted by the instant messaging server (3). The service management unit (4) has an interface which is configured such that it can display the message content or the call request received to the service manager and enable the service manager to create reply for the message content or answer the call request. The service management unit (4) transmits the message content, which is created by the service manager over the interlace comprised by thereof, to the instant messaging server (3) so as to be transmitted to the user (K) and in the event that the service manager accepts the call request, it sends the necessary notification to the instant messaging server (3) to connect the call.

In one embodiment of the invention, the service management unit (4) determines the service request of the user (K) by analysing the message content received by it, determines whether the user (K) provides the service requirements or not by analysing the service request, transmits notifications to related units for applying the service to the user (K) in the event that the requirements are provided, creates an automatic message content that comprises the actions taken in response to the user (K) request and sends b to the instant messaging server (3).

In another embodiment of the invention, the service management unit (4) takes the call by the voice response system in accordance with the call request received by it, receives the service request of the user (K) and analyses whether it meets the requirements or not, transmits notifications to related units for taking action in the event that the requirements are met.

In another embodiment of the invention, the service management unit (4) transmits the message content or the call request received it to an appliance server by means of an API (Application Programming Interface) and transmits the answer reported back by the server to the instant messaging server (3).

In one embodiment of the invention, after determining the service request of the user in accordance with the message content received by it, the service management unit (4) receives the user (K) information necessary for the demanded service—for example such as geographical location information—from the instant messaging server (3).

With the inventive system (1), transactions that the user (K) gets service over instant messaging application and service notifications are made to the user (K) are carried out. While the said transactions are being carried out, firstly the user (K) composes message or initiates call over the instant messaging application by the service definition information that is recorded in the directory of the user communication device (2) or input by him/her. For example, a message with “ATM” content is sent to a bank service which provides the location information of the closest ATM (Automated Teller Machine) to the user (K). In the event that the instant messaging server (3), which receives the message or the call information from the user communication device (2), determines that the definition information where the call or the message will be directed belongs to a service; it transmits the message or the call to the service management unit (4). The service management unit (4) determines the service demand of the user (K) by analysing the received message or the call. For example, the service management unit (4)—which receives the message having the content of “ATM”—determines that the user (K) demands the closest ATM location within the framework of the rules defined on thereof and receives the location information of the user communication device (2) from the instant messaging server (3). The service management unit (4) takes the necessary actions for providing the related service to the user (K) by getting in contact with the related units in accordance with the service request of the user (K). For example, the service management unit (4)—which gets the location information of the user communication device (2)—receives the ATM information that is closest to the user communication device (2) by querying the ATM information database. The service management unit (4) transmits the message content that it created by the service manager or created automatically to the instant messaging server (3) in order to notify the results of the actions taken to the user (K). The instant messaging server (3) transmits the message content received by it to the user communication device (2) over the data network (V) in order to be displayed in the instant messaging application.

It is possible to develop various embodiments of the inventive system (1), the invention cannot be limited to examples disclosed herein and it is essentially according to claims.

1. A system (1) enabling communication with service units over instant messaging application;comprising
at least one user communication device (2) which can perform data exchange with the data network (V) and whereon application can be run;
and characterized by
at least one instant messaging server (3) which takes the messages transmitted or the voice/video calls initiated over the data network (V) by the user (K) by means of the application running on the user communication device (2), forwards the messages or the calls to the users to whom they will be transmitted, determines the messages or the calls initiated towards the service units and forwards them to the related units, and transmits the messages or the calls reaching the user (K) to the user communication device (2) over the data network (V);
at least one service management unit (4) which answers the messages or the calls forwarded by the instant messaging server (3) or transmits the message content or the call request to the instant messaging server (3) in order to communicate with the user (K).

2. A system (1) according to claim 1; characterized by the communication device (2) which is configured such that it will enable the user (K) to write message, make choice, record the persons or the services—that s/he will communicate by the definition information required for communication—to the device directory on the interface provided by the application running on thereof.

3. A system (1) according to claim 1; characterized by the service management unit (4) which comprises an interface that is configured such that it can display the message content or the call request received to the service manager and enable the service manager to create reply for the message content or answer the call request.

4. A system (1) according to claim 1; characterized by the service management unit (4) which determines the service request of the user (K) by analysing the message content received by it, determines whether the user (K) provides the service requirements or not by analysing the service request, transmits notifications to related units for applying the service to the user (K) in the event that the requirements are provided.

5. A system (1) according to claim 4; characterized by the service management unit (4) which takes the call by the voice response system in accordance with the call request received by it, receives the service request of the user (K) and analyses whether it meets the requirements or not, transmits notifications to related units for taking action in the event that the requirements are met.

6. A system (1) according to claim 1; characterized by the service management unit (4) which transmits the message content or the call request received it to an appliance server by means of an API and transmits the answer reported back by the server to the instant messaging server (3).

7. A system (1) according to claim 1; characterized by the service management unit (4) which requests and receives the user (K) information necessary for the service that is demanded after it determines the service request of the user in accordance with the message content received by it.
